(19) United States
(12) Patent Application Publication
(10) Pub. No.: US 2010/0034997 A1
(43) Pub. Date: Feb. 11, 2010

(54) METAL-COMPOSITE BONDING METHODS AND COMPOSITIONS

(76) Inventors: Larry Buchanan, El Monte, CA (US); Charles Mathews, San Marino, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/421,987

(22) Filed: Apr. 10, 2009

Related U.S. Application Data
(60) Provisional application No. 61/044,184, filed on Apr. 11, 2008.

(51) Int. Cl. B32B 1/08; B65H 81/00; B29C 65/52

(52) U.S. Cl. 428/34.1; 156/185; 156/187; 156/307.7

(57) ABSTRACT

Embodiments described herein provide various processes for bonding metals to composites and for reinforcing the bonded metal and composite structures. In addition, the embodiments include the metal/composite compositions resulting from these processes.

### CROSS-REFERENCE TO RELATED APPLICATIONS

This application claims priority benefits under 35 U.S.C. §119 to co-pending U.S. provisional patent application Ser. No. 61/044,184, filed Apr. 11, 2008, which is herein incorporated by reference in its entirety.

### BACKGROUND OF THE INVENTION

1. Field of the Invention

The invention generally relates composites and to metal-composite structures and methods of making the same.

2. Description of the Related Art

The use of composite materials in aircraft structural components has grown steadily with each generation of aircraft. From initial applications in non-structural parts and secondary structures, composites have increasingly found use in some primary aircraft structures, particularly as applied to light aircraft, military fighters and helicopters. Yet to date, use of composites in the primary structures of aircraft has still been relatively limited.

Intensive efforts are underway, however, to design composite wing and fuselage structures and the use of composites in primary structures is likely to increase over the coming years. Such developments are being driven by the potential benefits of composites, chiefly in relation to reduced weight and operating cost. Realizing the full value of using composites, however, involves many technical challenges. For example, composite materials are less predictable than metals. In addition, monitoring structural integrity as well as nondestructive inspection of composites is more difficult than monitoring and inspection of metals. Shock, impact or repeated cyclic stresses can cause a composite laminate to separate at the interface between two layers (known as delamination) or to crack or separate at the interface between the composite and other materials of the structure. Compression fractures or failures can occur on a macro scale or at each individual reinforcing fiber, particularly in areas where composite structures are screwed, bolted or otherwise attached to other structural elements of the aircraft.

Some composites are brittle and have little reserve strength beyond the initial onset of failure, while others may have large deformation parameters and reserve energy-absorbing capacity past the onset of damage. Overall, the enormous variety of fibers and matrices that are available provides a very broad range of properties that can be designed into composite structures.

### SUMMARY OF THE INVENTION

Embodiments of the invention are directed to providing various processes for bonding metals to composites and for reinforcing the bonded metal and composite structures to produce a composite structure with high structural integrity. The combination of the metal/composite bonding and the subsequent composite layering, which incorporates the structural metal tubing into the composite “skin” or body of the aircraft, acts to distribute stress over a large surface area rather than focusing stresses at small, critical sites, such as sites of attachment of metal to composite. In addition, the technology encompasses the metal/composite structures resulting from these processes.

Thus, in one embodiment, a method is provided for bonding metal to composite including: positioning metal on a reinforcement material; applying matrix material to the reinforcement material; and curing the matrix material to form a bonded metal/composite structure.

Another embodiment of a method for bonding metal to composite includes: positioning metal on a first reinforcement material; applying matrix material to the first reinforcement material; curing the matrix material to form a metal/composite structure; at least partially wrapping the metal/composite structure in a second reinforcement material; applying a second matrix material to the second reinforcement material; and curing the second matrix material, thereby forming a bonded metal/composite structure.

In some embodiments, the metal used in the method is carbon steel or alloy steel, and in particular embodiments, the metal is chromoly, particularly chromoly 4130. In yet other embodiments, one or both of the first and second reinforcement materials comprise fiberglass, pre-impregnated fiberglass, aramid, carbon fiber or metal fiber, and in some aspects, one or both of the first and second matrix materials comprise epoxy, particularly Aeropoxy® PR2032 resin with one of Aeropoxy® PH3630, PH3660, or PH 3665 hardeners. In some embodiments, the method further includes: preparing a surface of the bonded metal/composite structure; priming the surface of the bonded metal/composite structure; and painting the surface of the bonded metal/composite structure; and in many aspects, the bonded metal/composite structure is primed with a UV protectant primer.

Yet other embodiments of the invention provide a bonded metal/composite structure made by: positioning metal on a first reinforcement material; applying matrix material to the first reinforcement material; curing the matrix material to form a metal/composite structure; wrapping the metal/composite structure in a second reinforcement material; applying a second matrix material to the second reinforcement material; and curing the second matrix material, thereby forming a bonded metal/composite structure. In some aspects of this embodiment, the bonded metal/composite structure is made by performing the additional processes of preparing a surface of the bonded metal/composite structure; priming the surface of the bonded metal/composite structure; and painting the surface of the bonded metal/composite structure.

This Summary is provided to introduce a selection of concepts in a simplified form that are further described below in the Detailed Description. This Summary is not intended to identify key or essential features of the claimed subject matter, nor is it intended to be used to limit the scope of the claimed subject matter. Other features, details, utilities, and advantages of the claimed subject matter will be apparent from the following written Detailed Description including those aspects illustrated in the accompanying drawings and defined in the appended claims.

In this specification, reference is made to embodiments of the invention. However, it should be understood that the invention is not limited to specific described embodiments. Instead, any combination of features and elements described herein, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the aspects, features, embodiments and advantages described herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a simplified flow diagram of a process for metal/composite bonding and manufacture, according to one embodiment of the invention.

FIG. 2 is a yet another simplified flow diagram of a process for metal/composite bonding and manufacture, according to one embodiment of the invention.

FIG. 3 is a cross-sectional view of a metal/composite structure in the process of manufacturing, according to one embodiment of the invention.

### DETAILED DESCRIPTION OF THE PREFERRED EMBODIMENT

Embodiments are described herein for providing various processes for bonding metals to composites and for reinforcing the bonded metal and composite structures to produce a composite structure with high structural integrity. In addition, the combination of the metal/composite bonding and the subsequent composite layering-in essence, incorporating the structural metal tubing into the composite “skin” or body of the aircraft-acts to distribute stress over a large surface area rather than focusing stresses at a small, critical sites such as sites of component attachments. Other embodiments include the metal/composite structures resulting from these bonding processes.

Composite materials (“composites” for short) are engineered materials made from two or more constituent materials with significantly different physical or chemical properties that remain separate and distinct on a microscopic level within the finished structure. There are two general categories of constituent materials: matrix and reinforcement. At least one portion of each material type is required. The matrix material surrounds and supports the reinforcement materials maintaining the reinforcement materials in relative position with one another, while the reinforcement materials impart mechanical and physical properties to enhance the properties of the matrix materials. The synergism between the matrix and reinforcement materials results in properties unavailable from the individual constituent materials; moreover, the wide variety of matrix and reinforcement materials allows a composite designer great latitude in choosing an optimum combination.

Most commercially-produced composites use a resin solution for the matrix material. There are many different resins or polymers available for use as matrix materials, which typically fall into several broad categories including but not limited to polyesters, vinylesters, epoxies, phenolics, polyimides, polyamides, polyproplylenes and the like. The reinforcement materials are often fibers but may include ground materials. Typically, the higher the percentage of reinforcement material in the composite, the stronger the product. Fiber-reinforced composite materials can be divided into two main categories, typically referred to as short fiber reinforced materials and continuous fiber reinforced materials. Continuous fiber reinforced materials often constitute a layered or laminated structure. The woven and continuous fiber styles are available in a variety of forms, such as those being pre-impregnated with the given matrix, dry (e.g., not pre-impregnated), unidirectional tapes of various widths, plain weave sheets, braided forms and stitched forms.

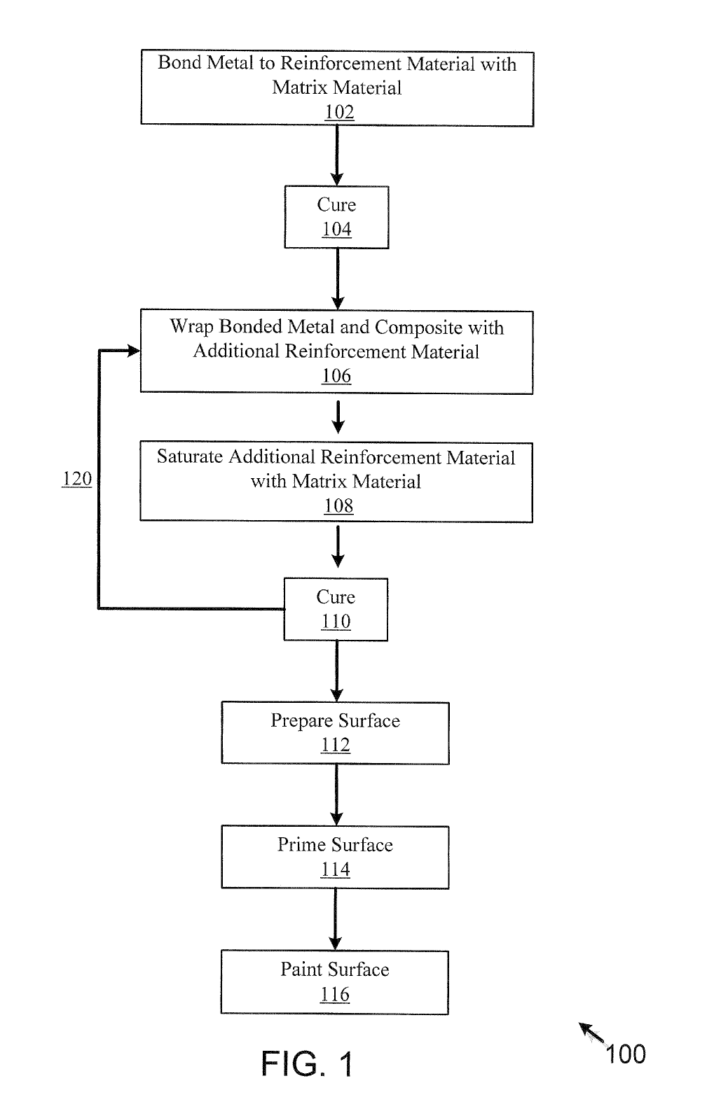

FIG. 1 is a simplified flow diagram of a process 100 for metal/composite bonding and manufacture according to one embodiment of the invention. First, a metal structure (e.g., metal tubing) is bonded to a first reinforcement material with a first matrix material 102, and the first reinforcement and matrix materials are then cured 104 to form a composite material. Once cured, the bonded metal and composite structure is wrapped with a second reinforcement material 106, and a second matrix material 108 is applied the second reinforcement material. In one embodiment, the second reinforcement material is saturated with the second matrix material 108. The resulting wrapped, bonded structure is then cured 110 to form a composite structure incorporating the metal tubing. Once cured, the wrapped, bonded composite structure may be sanded, smoothed or otherwise prepared 112, primed 114 and painted 116. Alternatively, after curing 110, the wrapped, bonded composite structure may be subjected to additional wrapping 106, saturating 108 and curing 110 procedures (loop 120), until a desired number of layers have been applied to the metal/composite structure. Once the desired number of layers has been applied, the finishing procedures of surface preparation 112, surface priming 114 and surface painting 116 may be performed. In addition, quality inspection processes may be performed at various stages throughout the process, particularly after each cure process. For example, if any voids are detected, additional matrix material may be used to fill them. Also, the metal/composite structure after cure step 104 (and/or cure step 110 or any other subsequent cure step) is preferably inspected for proper bonding.

Choosing the materials to be used with the processes described herein will depend on the precise application in which the composite will be used. In general, any metal may be used in the processes described herein, as long as the metal is appropriate for the composite structure and use intended. Illustrative metals for use in aircraft include carbon steels and alloy steels, such as 1020 steel and chromoly steels such as chromoly 4130 and 4140. Chromoly 4130 is a metal comprising 0.28 to 0.33% carbon, 0.4 to 0.6% manganese, 0.8 to 1.1% chromium, 0.15 to 0.25% molybdenum, 0.04% phosphorus, 0.04% sulfur, and 0.2 to 0.35% silicon in addition to iron; however, other metals with varying components but similar properties as chomoly 4130 may be used as well. The size and general configuration of the metal to be used, again, will differ according to the size, purpose and physical characteristics of the structure being constructed. In some applications of the processes described herein, chromoly 4130 tubing varying from one-half inch to one and one-half inch diameter was employed.

The first and second reinforcement materials used in 102 and 106 of the process described in FIG. 1 may be the same reinforcement material or may be different reinforcement materials depending on the application. In general, reinforcement materials are selected from the many different types of fiberglass, pre-impregnated fiberglass cloth, Kevlar® (aramids), boron, carbon fibers (also called graphite fiber), or metal fibers. For example, the first reinforcement material used in step 102 may comprise pre-impregnated fiberglass cloth (such as Pre-preg L-530, available from J.D. Lincoln Inc., Costa Mesa, Calif., comprising 7781 fiberglass cloth and 38% resin by weight), and the second reinforcement material may comprise 7781 fiberglass cloth without the epoxy pre-preg (available from Hexcel, Fullerton, Calif.).

Matrix materials used in the claimed invention preferably are epoxy materials. In general, epoxies are known for their excellent adhesion, chemical and heat resistance, mechanical properties and for electrical insulating properties. Epoxies are thermosetting polymers that cure (polymerize and crosslink) when mixed with a catalyzing agent or hardener. Epoxies may also, depending on the application, be formulated with flexibilizers, viscosity reducers, thickeners, accelerators, adhesion promoters and the like. Epoxies preferred for aerospace applications include Aeropoxy® PR2032 resin and Aeropoxy® PH3630, PH3660, and PH 3665 hardeners (available from PTM&W Industries, Santa Fe Springs, Calif.), as well as Aeropoxy® ES6220 or ES6228 liquid epoxy adhesive (also available from PTM&W Industries, Santa Fe Springs, Calif.). Other epoxies suitable for use include Jeffco Products Resin 1307 (“www.jeffcoproducts.com”) with hardeners 3102 or 3176 (details including the MSDS of the resin and hardners are available on the website, which is hereby incorporated by reference).

The procedures used to cure the composite in processes 104 and 110 depend on the resin and hardener (i.e., the epoxy) used, and may also depend on the reinforced material used. For example, if pre-impregnated L-530 fiberglass is used, curing may be accomplished by heating the metal/composite structure at 120° C. for 2.5 hours. When using Aeropoxies or other epoxies, curing is accomplished by following the manufacturer's specifications; for example, curing at 72° C. for 24 hours. Typically, curing at elevated temperatures decreases the cure time needed.

In process 112, the surface of the bonded metal/composite optionally is prepared, such as by, e.g., sanding, smoothing, texturing, and the like. Once the surface is prepared in process 112, it is primed in process 114, preferably using a UV protectant primer to protect the composite from aging (particularly losing flexibility and adhesion properties) due to UV exposure. UV protectants available for use with the embodiments of the invention are numerous and vary widely in their life expectancy. The methods of applying UV protectants also vary, allowing manufacturing/process designers significant flexibility. In some implementations, UV inhibitors or resin additives may be blended into the resin (matrix) during composite manufacturing. Such UV inhibitors generally take two forms: a stabilizer that acts chemically with the resin rendering the cured resin less susceptible to the effects of UV degradation (cracking, peeling, etc.); or a pigmentation such as titanium dioxide (TiO₂) that acts as a barrier between the resin and harmful effects of UV radiation. In other implementations coatings are used. Coatings are available with various forms and vary in their methods of application, e.g., molding, spraying and painting. Coatings are available in various base chemistries allowing one to specify a UV coating that is chemically similar to the composite resin, if desired. In certain aspects of the claimed invention, UV Smooth Prime (available from Poly-Fiber Aircraft Coatings, Riverside, Calif.), a crosslinkable waterborne urethane, is used as a primer. After application of the primer, the wrapped, bonded composite structure is allowed to dry according to the manufacturer's specifications, and then it is sealed using, e.g., a two-part epoxy primer such as Poly-Fiber EP-420 or Randolph Epibond Primer (also available from Poly-Fiber Aircraft Coatings, Riverside, Calif.). The sealant is then allowed to cure, if necessary. Once the wrapped, bonded composite structure has been primed in process 114, it may be painted in process 116. Typically any appropriate paint or coating may be used. When UV Smooth Prime is used, often a top coat urethane is used, such as Aerothane or Ranthane.

In general, once the reinforcement and matrix materials are combined, compacted, and processed (cured), the shape of the composite structure is essentially set; thus, molding procedures are often used to shape the composite structure appropriately. For many molding methods, it is convenient to refer to one mold piece as a “lower” mold and another mold piece as an “upper” mold. Lower and upper refer to the different faces of the molded panel, rather than the mold's configuration in space. In this convention, there is always a lower mold. The molded product is often referred to as a panel or casting. In some applications, open molding may be employed. Open molding uses a rigid, one-sided mold that shapes only one surface of the panel. The opposite surface is determined by the amount of material placed upon the lower mold. Reinforcement materials may be placed manually or robotically, and may take the form of continuous fiber sheets or chopped fiber. The matrix (again, generally an epoxy comprising resin, hardener, and in some applications, an adhesive or other formulator) can be applied with a pressure roller, spray device, or manually using a brush or extruding device. Open molding is generally done at ambient temperature and pressure.

In other applications, vacuum bag molding is employed. Vacuum bag molding typically uses a two-sided mold set that shapes both surfaces of the panel. On the lower side is a rigid mold and on the upper side is a flexible membrane or vacuum bag. The flexible membrane can be a reusable silicone material or an extruded polymer film such as nylon. The fiber may be pre-impregnated with resin, or a liquid matrix material may be introduced to a dry fiber prior to applying the flexible film. A vacuum is then applied at either ambient or elevated temperature with ambient atmospheric pressure acting on the vacuum bag. Pressure bag molding is a variation of vacuum bag molding, where pressure and/or heat is applied to the flexible film so as to force out excess resin along with trapped air. In yet another molding process, autoclave molding employs a two-sided mold set, with a rigid lower mold and a flexible upper mold where a vacuum is applied to the mold cavity. Autoclave molding typically involves both elevated pressure and elevated temperature, maximizing a high fiber volume fraction and a low void content.

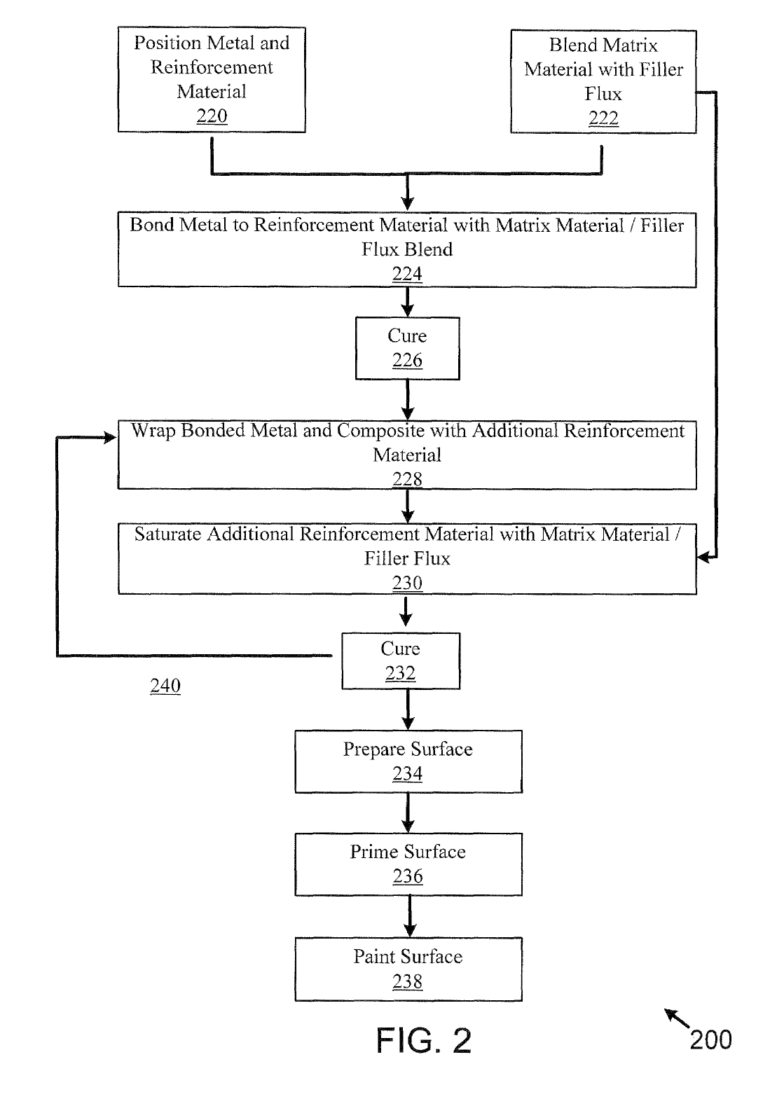

FIG. 2 is a simplified flow diagram of an alternative process 200 for metal/composite bonding and manufacture according to other embodiments of the invention. In the process outlined in FIG. 2, a metal structure (e.g., metal tubing) is positioned adjacent a first reinforcement material in process 220. In process 222, a matrix material is blended with a filler flux, that is then used in process 224 to bond the metal to the reinforcement material. The matrix material with the flux filler is then cured 226 to form a composite with the reinforcement material, bonding the composite to the metal. Next, the bonded metal/composite structure is wrapped with additional reinforcement material in process 228, and the wrapped, bonded composite structure is then saturated with, e.g., blended matrix material and filler flux in process 230. The matrix material/filler flux is allowed to cure 232 forming a composite structure. Once cured, the wrapped, bonded composite structure may be sanded, smoothed or otherwise prepared 234, primed 236 and painted 238. Alternatively, after curing 232, the wrapped, bonded structure may be subjected to additional wrapping 228, saturating 230 and curing 232 procedures (loop 240), until a desired number of layers have been applied to the composite structure. Once the desired number of layers has been applied, the finishing procedures of surface preparation 234, surface priming 236 and surface painting 238 may be performed.

The process described in FIG. 2 differs from the process described in FIG. 1 in that a filler flux is blended with the matrix material before applying the matrix material to the reinforcement material to form the composite. The filler flux may be a flexibilizer, viscosity reducer, thickener, accelerator, adhesion promoter, or other desired additive. In some implementations, the filler flux is a silicon dioxide filler such as Cab-o-sil (a synthetic, amorphous fumed silicon dioxide, manufactured by Cabot Corp. and available from Eager Plastics, Inc., Chicago Ill.), a carbon flux or an aramid flux, used in various ratios (e.g., 30/70, 40/60, 50/50, 60/40, 70/30 matrix material to filler flux) to thicken the matrix material (e.g., Aeropoxy®).

FIGS. 1 and 2 are merely exemplary, and the invention is not so limited. For example, in other embodiments, a composite may be provided and then subsequently attached (e.g., bonded) to a metal structure (e.g. metal tubing). This differs from embodiments described above in which the composite is formed on the metal structure by bonding reinforcement material to the metal, applying a matrix to the reinforcement material to form a bond between the reinforcement material and the metal and then curing the bond. Further, it is also contemplated that a matrix (e.g., an epoxy resin and hardner) is applied to a reinforcement material first, and then, before completing any curing step, the resultant uncured composite is brought into contact with a metal structure; after which the metal/composite structure can be cured.

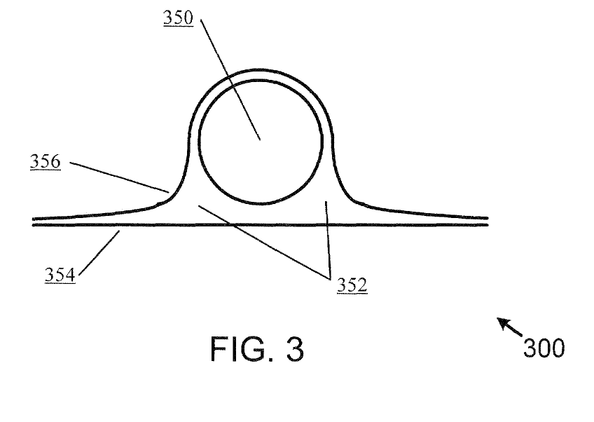

FIG. 3 is a cross-sectional view of a metal/composite structure 300. FIG. 3 shows a metal tube, preferably a chromoly tube, in cross section 350, positioned upon a reinforcement material 354, such as a fiberglass sheet or a pre-impregnated fiberglass sheet. Between the metal tubing 350 and the reinforcement material sheet 354 is a matrix material 352, which both saturates the reinforcement material sheet 354 and bonds the reinforcement sheet 354 to the metal 350. Once that the matrix material 352 has been cured and the reinforcement material 354 and matrix material 352 have formed a composite, a layer of additional reinforcement material 356 is added to the bonded metal/composite structure. Once the additional reinforcement material 356 is positioned, additional matrix material (not shown) is used to saturate the additional reinforcement material 356. The additional matrix material is then cured, and additional layers of reinforcement material and matrix material may be added until a desired thickness of composite is achieved. Typically, the composite laminate will be thicker where stress is high (e.g., structural components such as aircraft wings, fuselages, etc., and at joints and points of attachment) and thinner in non-structural areas. The unique combination of the metal/composite bonding and the subsequent composite layering acts to incorporate the metal structural elements into the “skin” or body of the aircraft, thereby distributing stress over the large surface area of the structure rather than focusing stresses at small, critical sites where the metal structural elements would otherwise be attached to the composite structural elements.

Experimental

L-530 Solution Epoxy Prepreg (available from J.D. Lincoln Inc., Costa Mesa, Calif.) was layered in a mold in a dry lay up procedure. The Prepreg was then cured in a vacuum molding process for 2.5 hours at 120° C. Alternatively, a wet lay up procedure may be employed where 7781 cloth is laid over the mold, wetted with epoxy resin and allowed to cure. After curing, the cured composite was sanded and trimmed as needed. One inch OD chromoly 4130 tubing was then positioned on the cured composite and the composite and metal were bonded together using ES6228. The ES6228 was allowed to cure. Once cured, the bonded chromoly/composite structure was inspected to assure proper bonding, and then sanded as needed. All voids, unfilled or sharp areas were filled with flux or Cab-o-sil mixed with epoxy resins. Next, the bonded chromoly/composite structure was wrapped in 7781 fiberglass cloth (available from Hexcel, Fullerton, Calif.) where there is at least an inch of 7781 fiberglass cloth positioned on the composite on each side of the chromoly tubing. Next, in a wet lay up process, Aeropoxy® PR2032 resin and Aeropoxy® PH3630 hardener (available from PTM&W Industries, Santa Fe Springs, CA) were combined according to the manufacturer's specifications and used to saturate the 7781 fiberglass cloth. The composite structure was then cured at room temperature for 24 hours. The wrapping, saturating and curing process was repeated two additional times for a total of three layers. Once the third layer of the composite structure was cured, the composite structure was sanded, primed with UV Smooth Prime (available from Poly-Fiber Aircraft Coatings, Riverside, Calif.), sealed with Poly-Fiber EP-420 (also available from Poly-Fiber Aircraft Coatings, Riverside, Calif.), and painted with a top coat urethane.

The present specification provides a description of various implementations of methods to make bonded metal and composite structures, reinforce the bonded metal and composite structures, as well as a description of the bonded metal and composite structures themselves. Although various aspects of this technology have been described above with a certain degree of particularity, or with reference to one or more individual aspects, those skilled in the art could make numerous alterations to the disclosed aspects without departing from the spirit or scope of the technology. Since many alterations can be made without departing from the spirit and scope of the presently described technology, the appropriate scope of the invention resides in the appended claims. It is intended that all matter contained in the above description and shown in the accompanying drawings shall be interpreted as illustrative only of particular aspects and should not be limited to the implementations shown. Changes in detail or structure may be made without departing from the basic elements of the present technology as defined in the following claims. In the claims, unless the term “means” is used, none of the features or elements recited therein should be construed as means-plus-function limitations pursuant to 35 U.S.C. §112, π6.

What is claimed is:

1. A method for bonding metal to composite, comprising:
positioning metal on a first reinforcement material;
applying matrix material to the first reinforcement material;
curing the matrix material to form a metal/composite structure;
at least partially wrapping the metal/composite structure in a second reinforcement material;
applying a second matrix material to the second reinforcement material; and
curing the second matrix material, thereby forming a bonded metal/composite structure.

2. The method of claim 1, wherein the metal is a metal tube of an aircraft.

3. The method of claim 2, wherein the metal is chromoly 4130.

4. The method of claim 1, wherein one or both of the first and second reinforcement materials are fiberglass, pre-impregnated fiberglass, aramid, carbon fiber or metal fiber.

5. The method of claim 4, wherein one or both of the first and second reinforcement materials are fiberglass or pre-impregnated fiberglass.

6. The method of claim 1, wherein one or both of the first and second matrix materials are epoxy.

7. The method of claim 6, wherein the epoxy is Aeropoxy® PR2032 resin with Aeropoxy® PH3630, PH3660, or PH 3665 hardener.

8. The method of claim 1, further comprising the steps of:
preparing a surface of the bonded metal/composite structure;
priming the surface of the bonded metal/composite structure; and
painting the surface of the bonded metal/composite structure.

9. The method of claim 8, wherein the surface of the bonded metal/composite structure is primed with a UV protectant primer.

10. A method for bonding metal to composite, comprising:
providing a first composite;
positioning the first composite into contact with a metal structure;
forming an epoxy bond between first composite and the metal structure;
curing the epoxy bond to formed a bonded metal/composite structure;
at least partially wrapping the first composite of the bonded metal/composite structure in a reinforcement material;
applying a matrix material to the reinforcement material; and
curing the matrix material, thereby forming second composite which is bonded to the first composite of the metal/composite structure.

11. The method of claim 10, wherein the metal is carbon steel or alloy steel.

12. The method of claim 11, wherein the metal is chromoly 4130.

13. The method of claim 10, wherein the reinforcement material is fiberglass, pre-impregnated fiberglass, aramid, carbon fiber or metal fiber.

14. The method of claim 13, wherein the reinforcement material is pre-impregnated fiberglass.

15. The method of claim 10, wherein the matrix material is epoxy.

16. The method of claim 10, wherein the metal structure is a metal tube of an aircraft.

17. A bonded metal/composite structure, comprising:
a metal tube of an aircraft bonded to a first reinforcement material by a first cured matrix material, forming a metal/composite structure; and
a second reinforcement material wrapped around the first reinforcement material of the metal/composite structure, the second reinforcement material bonded to the first reinforcement material by a second cured matrix material.

18. The bonded/metal composite structure of claim 17, wherein a surface of the second reinforcement material is disposed is:
primed; and
painting.

19. A method for bonding metal to composite, comprising:
positioning chromoly on fiberglass;
applying epoxy to the fiberglass; and
curing the epoxy to bond the chomoly to the fiberglass, thereby forming a chromoly/fiberglass structure.

20. The method of claim 19, further comprising:
wrapping the chromoly/fiberglass structure in additional fiberglass;
applying additional epoxy to the additional fiberglass; and
curing the additional epoxy.
